(19) United States
(12) Patent Application Publication
(10) Pub. No.: US 2008/0259023 A1
(43) Pub. Date: Oct. 23, 2008

(54) Method and System of Making a Computer as a Console for Managing Another Computer

(75) Inventor: Chih-Hsien Chang, Taipei Hsien (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ATEN INTERNATIONAL CO., LTD., Taipei Hsien (TW)

(21) Appl. No.: 11/737,349

(22) Filed: Apr. 19, 2007

(51) Int. Cl. G09G 5/00

(52) U.S. Cl. 345/156

(57) ABSTRACT

A video signal processor encodes a video signal received from the target computer through the computer interface. A peripheral interface controller is coupled to the video signal processor, and transmits the encoded video signal to the console computer in a peripheral interface standard through the console interface. A console module is coupled to the console computer, and decodes the encoded video signal for displaying on the console computer and transmits a manipulation signal to the target computer through the console interface, the peripheral interface controller and the computer interface. A method of making the console computer as a console for managing the target computer is also disclosed.

### BACKGROUND

1. Field of Invention

The present invention relates to computer management. More particularly, the present invention relates to managing a computer by using another computer equipped with at least one display and at least one human interface device (HID) as a console, which can display images and input commands.

2. Description of Related Art

With the rapid development in information technology, computers and their peripherals have become very popular. Typically, each computer is equipped with one console device including a keyboard, a mouse and a monitor. However, this kind of configuration is a waste of money and occupies too much space if there is only one user to manipulate these computers.

Referring to FIG. 1, a keyboard-video-mouse (KVM) switch 100 is therefore proposed to use a single console device 114 to manage several computers 112. Video signal of the computer 112 should be transmitted to the monitor of the console device 114 via the KVM switch 100 while commands from the console device 114 should be sent to the computer 112 via the KVM switch 100. Thus, the console device 114 is capable of controlling each target computer 112. Using the KVM switch 100 can reduce hardware cost and decreases waste of space while simultaneously conquering the problem of compatibility between different interfaces.

### SUMMARY

According to one embodiment of the present invention, a computer management system of making a console computer equipped with a display and at least one human interface device as a console for managing a target computer is disclosed. The computer management system comprises a computer interface, a console interface, a video signal processor, a peripheral interface controller and a console module. The computer interface is arranged to connect to the target computer, and the console interface is arranged to connect to the console computer. The video signal processor encodes a video signal received from the target computer through the computer interface. The peripheral interface controller is coupled to the video signal processor, and transmits the encoded video signal to the console computer in a peripheral interface standard through the console interface. The console module is coupled to the console computer, and decodes the encoded video signal for displaying on the display, and transmits a manipulation signal generated by the human interface device to the target computer through the console interface, the peripheral interface controller and the computer interface.

According to another embodiment of the present invention, a method of making a console computer equipped with at least one display and at least one human interface device as a console for managing a target computer is disclosed. A video signal received from the target computer is encoded and then transmitted to the console computer in a peripheral interface standard. Then, the encoded video signal is decoded for displaying on the display of the console computer, and a manipulation signal generated by the human interface device is transmitted from the console computer to the target computer for managing the target computer.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a conventional KVM switch;

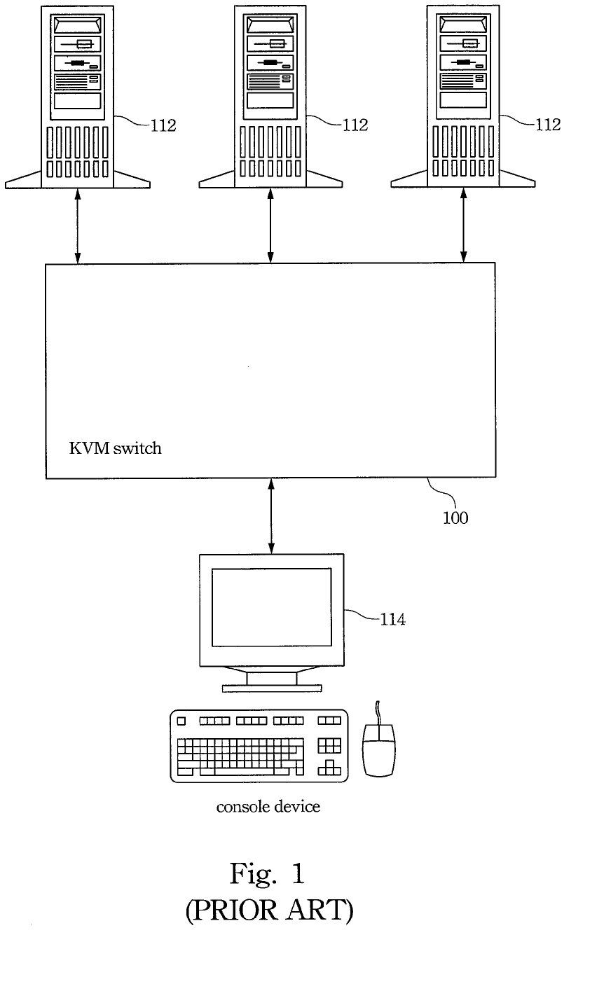

FIG. 2 is a computer management system according to one embodiment of the present invention; and

FIG. 3 is a flow chart of a method according to one embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

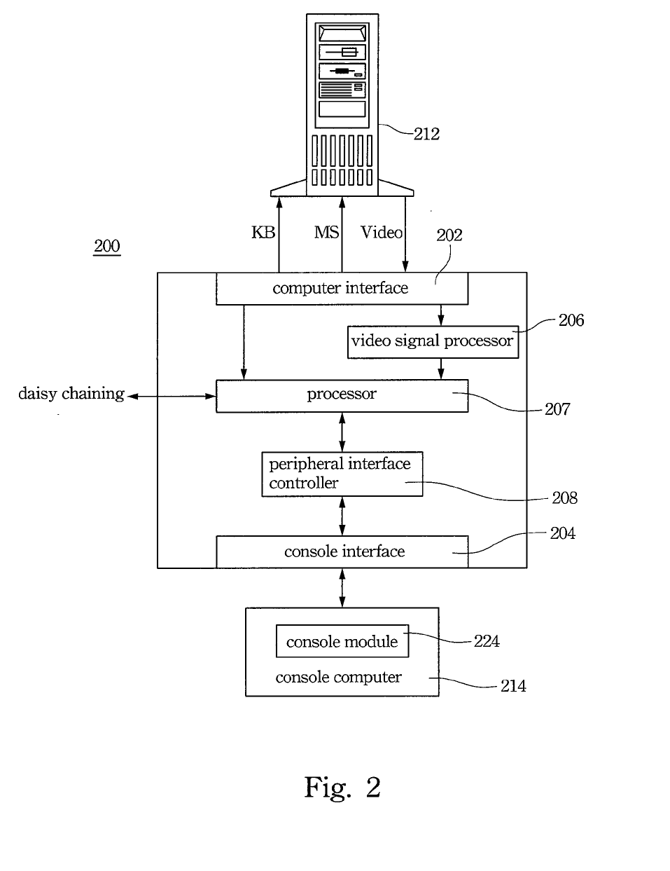

FIG. 2 is a computer management system 200 according to one embodiment of the present invention, which can make a console computer 214 as a console for managing a target computer 212. The computer management system 200 has a computer interface 202, a console interface 204, a video signal processor 206, a peripheral interface controller 208 and a console module 224. The computer interface 202 is arranged to connect to the target computer 212, and the console interface 204 is arranged to connect to the console computer 214, and the console computer can be a portable computer, such as a notebook computer, but any computer equipped with a display and at least one human interface device may be applicable.

The video signal processor 206 receives a video signal (Video) of the target computer 212 through the computer interface 202. The video signal processor 206 may further encode the video signal into an encoded video signal. The peripheral interface controller 208 is coupled to the video signal processor 206, and transmits the encoded video signal to the console computer 214 through the console interface 204 in a peripheral interface standard.

The console module 224 may be coupled to the console computer 214, and is capable of decoding the encoded video signal for displaying on the display of the console computer 214. The console module 224 may further be capable of transmitting a manipulation signal (MS) (KB) to the target computer 212 through the console interface 204, the peripheral interface controller 208 and the computer interface 202. The manipulation signal is generated by the human interface device, such as a keyboard or a mouse, of the console computer 214 for managing the target computer 212.

In addition, as illustrated in FIG. 2, the embodiment implements the computer management system 200 by two parts, one is an integrated hardware unit including the computer interface 202, the video signal processor 206, the processor 207, the peripheral interface controller 208 and the console interface 204 and the other is separate from the integrated hardware unit and includes the console module 224 which may be software (e.g. a program), hardware (e.g. a chip) or their combination coupled to the console computer 214.

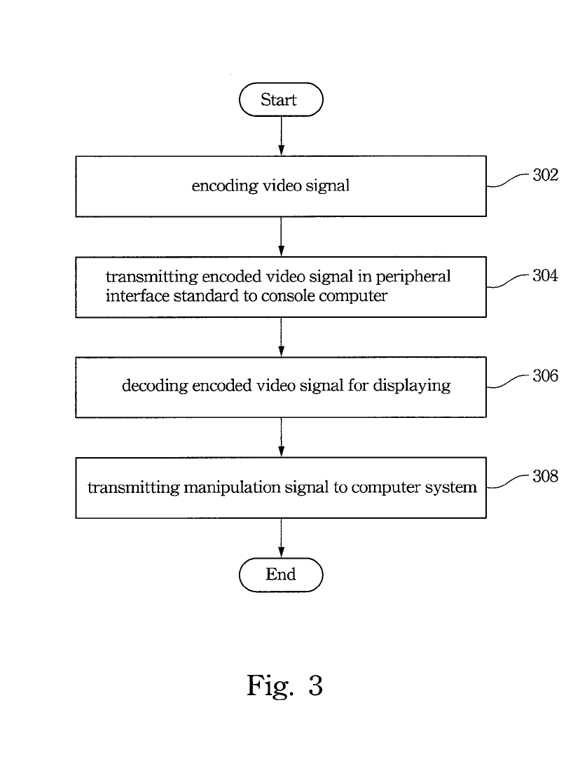

FIG. 3 is a flow chart of a method according to one embodiment of the present invention, which can make a console computer as a console for managing a target computer. The following description is made with reference to FIGS. 2 and 3. A video signal received from the target computer 212 is encoded (step 302) and then transmitted to the console computer 214 in a peripheral interface standard (step 304). Then, the encoded video signal is decoded for displaying an image on the console computer 214 (step 306), and a manipulation signal is transmitted from the console computer 214 to the target computer 212 (step 308).

In the embodiments, the computer management system 200 further has a processor 207 coupled between the video signal processor 206 and the peripheral interface controller 208. The processor 207 can communicate with another computer management system which is identical to or similar with the computer management system 200 by daisy chaining, and therefore communicate with another target computer or another console computer coupled thereto. The daisy chaining may be achieved by USB connection or other available manners.

More specifically, the processor 207 can route communication paths among the target computers and the console computers, which may be directly coupled to the computer management system 200 or indirectly coupled to the other computer management system by daisy chaining.

The console module 224 can be implemented in a program which is executed by the console computer 214. Alternatively, the console module 224 can be implemented in an IC chip which is configured in the console computer 214. In other words, the console module 224 may be a combination of hardware that can provide video signal decoding, video displaying and manipulation signal conversion functions, or a combination of software which is executed by the console computer 214 to provide those functions. Persons skilled in the art should select the proper form, whether in hardware, software or their combinations, to implement the console module 224 as needed.

The manipulation signal may include a keyboard signal, a mouse signal or their combinations, that is, the signals inputted by the user using the human interface device such as a keyboard, touch pad, or mouse configured on or externally coupled to the console computer 214. The manipulation signal may further include audio signals such that they may be recorded or played by the microphone or speakers of the console computer 214. The console module 224 can transmit the manipulation signal to the peripheral interface controller 208 in the peripheral interface standard through the console interface 204. In addition, the console module 224 can further display an image on the display of console computer 214 according to the decoded video signal. The peripheral interface standard used in the transmission between the peripheral interface controller 208 and the console module 224 can be a USB interface standard or an IEEE 1394 interface standard.

In operation, while the manipulation signal is generated by the human interface device, the console module 224 firstly transmits it to the peripheral interface controller 208 in the peripheral interface standard, and the peripheral interface standard 208 then transmit the manipulation signal to the target computer 212 in a proper standard for the target computer 212, such as the USB or PS2 interface standard. The video signal processor 206 can further encode the video signal received from the target computer 212 in a compression format, such as Moving Pictures Experts Groups (MPEG) or other proper formats, so as to enhance the performance of video transmission.

Accordingly, the embodiments stated above can allow at least one console computer to conveniently access and control target computers, that is, by utilizing the monitor and keyboard originally configured on the console computer to serve as a convenient console to control the target computers.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A computer management system of making a console computer equipped with at least one display and one human interface device as a console for managing a target computer, comprising:
a computer interface arranged to connect to the target computer;
a console interface arranged to connect to the console computer;
a video signal processor arranged to encode a video signal received from the target computer through the computer interface;
a peripheral interface controller coupled to the video signal processor, wherein the peripheral interface controller is arranged to transmit the encoded video signal to the console computer in a peripheral interface standard through the console interface; and
a console module coupled to the console computer, wherein the console module is arranged to decode the encoded video signal for displaying on the display, and transmit a manipulation signal generated by the human interface device to the target computer through the console interface, the peripheral interface controller and the computer interface.

2. The computer management system of making a console computer as a console as claimed in claim 1, further comprising:
a processor coupled between the video signal processor and the peripheral interface controller, wherein the processor is capable of communicating with another computer management system by daisy chaining, so as to communicate with another target computer or another console computer.

3. The computer management system of making a console computer as a console as claimed in claim 2, wherein the processor is arranged to route communication paths among the target computers and the console computers.

4. The computer management system of making a console computer as a console as claimed in claim 1, wherein the console module is implemented in a program which is executed by the console computer.

5. The computer management system of making a console computer as a console as claimed in claim 1, wherein the console module is implemented in an IC chip which is configured in the console computer.

6. The computer management system of making a console computer as a console as claimed in claim 1, wherein the manipulation signal is a keyboard signal, a mouse signal or an audio signal.

7. The computer management system of making a console computer as a console as claimed in claim 1, wherein the console module is arranged to transmit the manipulation signal to the peripheral interface controller in the peripheral interface standard through the console interface.

8. The computer management system of making a console computer as a console as claimed in claim 1, wherein the video signal processor is capable of compressing the video signal with a compression format.

9. The computer management system of making a console computer as a console as claimed in claim 8, wherein the compression format is MPEG format.

10. The computer management system of making a console computer as a console as claimed in claim 1, wherein the peripheral interface standard is a USB interface standard or an IEEE 1394 interface standard.

11. A method of making a console computer equipped with at least one display and one human interface device as a console for managing a target computer, comprising the steps of:
encoding a video signal received from the target computer;
transmitting the encoded video signal to the console computer in a peripheral interface standard;
decoding the encoded video signal for displaying on the display of the console computer; and
transmitting a manipulation signal generated by the human interface device from the console computer to the target computer for managing the target computer.

12. The method of making a console computer as a console as claimed in claim 11, further comprising:
communicating with another target computer or console computer by daisy chaining.

13. The method of making a console computer as a console as claimed in claim 12, further comprising:
routing communication paths among the target computers and the console computers before transmitting the compressed video signal and the manipulation signal.

14. The method of making a console computer as a console as claimed in claim 11, wherein the encoded video is decoded and the manipulation signal is transmitted by a program which is executed by the console computer.

15. The method of making a console computer as a console as claimed in claim 11, wherein the encoded video is decoded and the manipulation signal is transmitted by an IC chip which is configured in the console computer.

16. The method of making a console computer as a console as claimed in claim 11, wherein the manipulation signal is a keyboard signal, a mouse signal or an audio signal.

17. The method of making a console computer as a console as claimed in claim 11, wherein the manipulation signal is transmitted in the peripheral interface standard.

18. The method of making a console computer as a console as claimed in claim 11, wherein the peripheral interface standard is a USB interface standard or an IEEE 1394 interface standard.

19. The method of making a console computer as a console as claimed in claim 11, wherein the video signal is encoded in a compression format.

20. The method of making a console computer as a console as claimed in claim 11, wherein the compression format is MPEG format.
